(19) United States
(12) Patent Application Publication
(10) Pub. No.: US 2005/0011664 A1
(43) Pub. Date: Jan. 20, 2005

(54) Structure of a cable

(76) Inventor: Chang-Chi Lee, Hu-Wei Town (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/619,410

(22) Filed: Jul. 16, 2003

(51) Int. Cl. H02G 3/00

(52) U.S. Cl. 174/102 SC; 174/106 R

(57) ABSTRACT

An improved structure of a cable featuring an enhanced shield layer, with the arrangement comprised of a conductor, an insulation layer, a metal braid layer, an outer jacket, and an enhanced shield layer disposed between the insulation layer and the metal braid layer. The enhanced shield layer can be conductive plastic, conductive carbon black, conductive colorant, conductive coating, conductive metallic powder, or metal fiber, any of which eliminates electrostatic noise generated by a variety of causes in audio/video cables and thereby solves the problem of electrostatic discharge

### BACKGROUND OF THE INVENTION

1) Field of the Invention

The invention herein relates to an audio/video cable, specifically an improved structure of a cable featuring a built-in enhanced shield layer, with the arrangement comprised of a conductor, an insulation layer, a metal braid layer, an outer jacket, and an enhanced shield layer disposed between the insulation layer and the metal braid layer, wherein the enhanced shield layer can be a conductive plastic, conductive carbon black, conductive colorant, conductive coating, conductive metallic powder, or metal fibers, any of which eliminates electrostatic noise generated by a variety of causes in audio/video cables and thereby solves the problem of electrostatic discharge

2) Description of the Prior Art

Apace with the growing demand for electronic and electrical equipment in daily life, shielding against various forms of electromagnetic interference has become a major concern in electronic and electrical cable manufacturing. Since there are more and more types of equipment that are proximity sources of interference, ranging from power supplies and high-frequency emission electrical appliances to VHF/UHF cordless and cellular telephones that rely on both radio signals and electromagnetic waves, there is really no place that is free of interfering waves. Such interference mainly consists of two types: electromagnetic interference and radio frequency interference. Electromagnetic interference is low-frequency interference; typical sources of electromagnetic interference include electric motors, fluorescent lights, and power supply cables. Radio frequency interference refers to interference in the wireless frequency spectrum, primarily high-frequency interference that is usually generated by radio communication equipment such as cordless telephones, television broadcasts, and radar.

Another type of interference is known as electrostatic interference, which comes from electrostatic discharge; friction produces electricity because as rubbing occurs, stronger electrons attract other electrons, thereby causing movement that results in an electron imbalance which builds up a static electrical charge on the surface of an object. The source of such interference is sometimes the very air in which connected wires are present, wherein every connected wire essentially becomes a radio antenna that receives interfering waves into electronic equipment which could, for example, result in unexpected audio/video signal distortion. Since there are many types of interfering signals that affect audio signal transmission in cables, such cables require good shielding; a poorly shielded cable is like an antenna that is susceptible to omni-present electromagnetic interference.

### SUMMARY OF THE INVENTION

The objective of the invention herein is to provide an improved structure of a cable to effectively suppress atmospheric electromagnetic fields that affect transmission circuitry and reduce electromagnetic radiation from signals conveyed by cable.

To achieve the said objective, the invention herein utilizes the following technological means: The improved structure of a cable is comprised of a conductor, an insulation layer, a metal braid layer, and an outer jacket, and an enhanced shield layer disposed between the insulation layer and the metal braid layer. The said enhanced shield layer can be conductive plastic, conductive carbon black, a substrate of metal plating deposited onto the exterior surface of the insulation layer, or a substrate of conductive colorant or conductive coating applied onto the exterior surface of the insulation layer.

To compare the invention herein with the prior art, since the enhanced shield utilizes a conductive plastic, conductive carbon black, conductive colorant, conductive coating, or conductive metallic powder, it effectively suppresses atmospheric electromagnetic fields that affect signal transmission and eliminates electrostatic noise generated by a variety of causes in audio/video cables.

Shielding is a major method of electromagnetic control that is capable of effectively restraining interference. The utilization of a shielded cable enables the thorough suppression of atmospheric electromagnetic fields that affect signal transmission, including the prevention of signal loss, excessive noise, character transmission faults, and other signal errors, while also reducing electromagnetic radiation from signals conveyed by cable, minimizing the scope of proximity electromagnetic interference, and averting data losses and leaks.

In the field of audio and video cables, shielded cables are mainly utilized for microphone, guitar, and other similar devices. Since the signals of such sources are at relatively low levels, they must be amplified. However, interfering signals mixed in during the amplification process results in serious consequences; if a cable picks up the signals of a radio station transmitter, the detected radio frequency waves will be amplified and mixed with the audio frequency signal, the combination ending up as predominantly interference.

Common shielding methods of cables include the following:

Screen-type shielding: The most typical variation is metal strands braided into a shield layer. Although the effectiveness of such shielding can be raised by increasing the weave density of the braid, effectiveness is reduced as frequency becomes higher. This occurs because when the frequency rises to a certain point, its wavelength approaches the hole diameter dimensions of the braiding, which starts to function as an antenna, thereby lowering the isolation capability of the shield layer.

The shield layer of a typical shielded cable consists of a metal braid and since the conventional method of braiding leaves gaps at the conductor crossover portions, shielding efficiency rarely exceeds 95 percent and, furthermore, air easily penetrates the gaps and oxidizes the conductors.

Screen-type shielding provides for excellent structural integrity because it is pliable but firm and has a prolonged service life. Such shielding is an ideal choice for reducing low frequency interference and it also has a lower direct current impedance compared to foil shielding. Screen-type shielding is extremely efficient in the audio frequency and radio frequency spectrums; screen-type shielding coverage efficiency is normally quite high and its shielding effectiveness is outstanding.

Foil shielding: Foil shielding is a layer of metal foil (aluminum foil or copper foil, etc.) attached onto a polyester resin or polypropylene film that is axially or diagonally wrapped around the exterior surface of an electrical cable. Such film shielding provides for a degree of mechanical strength as well as excellent insulation characteristics; foil shielding is capable of 100-percent cable coverage and is utilized along with a lead wire to enable easier connection and facilitate the grounding of electrostatic discharge.

Foil shielding is lightweight, physically small, and lower in price than screen-type shielding. Often quite effective in the radio frequency spectrum, foil materials and shielding structures results in a wide range of dissimilar shielding capabilities.

### BRIEF DESCRIPTION OF THE DRAWINGS

FIG. 1 is a cross-sectional drawing of the invention herein.

FIG. 2 is a cross-sectional drawing of another embodiment of the invention herein.

FIG. 3 is a cross-sectional drawing of yet another embodiment of the invention herein.

### DETAILED DESCRIPTION OF THE INVENTION

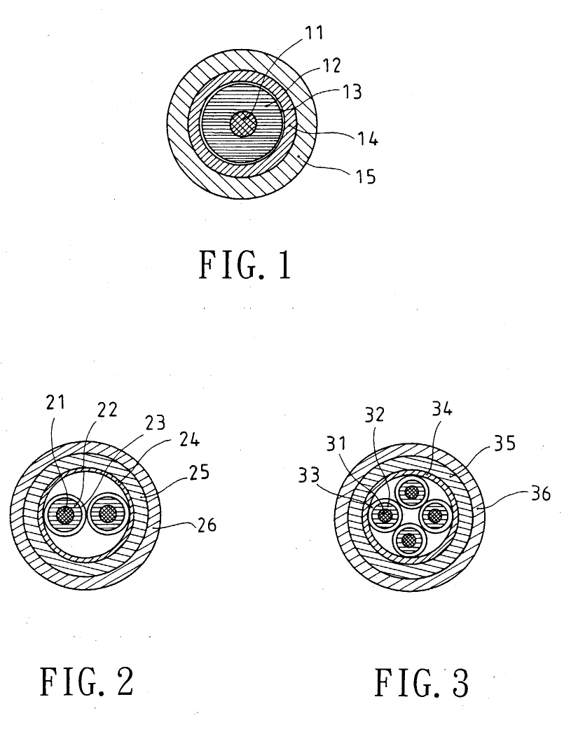

In the first embodiment of the invention herein, referring to FIG. 1, the improved structure of a cable is comprised of a conductor 11, an insulation layer 12, a metal braid layer 14, and an outer jacket 15, and an enhanced shield layer 13 disposed between the insulation layer 12 and the metal braid layer 14; the said enhanced shield layer 13 can be a conductive plastic, conductive carbon black, conductive colorant, conductive coating, or conductive metallic powder; alternatively, a substrate of metal plating or conductive metal powder can be applied onto the exterior surface of the insulation layer 12 along the inside of the metal braid layer 14.

Most metals are conductors capable of reflecting and absorbing very large amounts of electromagnetic interference, and the higher the conductivity of the material, the better the shielding capability; virtually all plastics are insulators and, therefore, penetrable by electromagnetic radiation. Plastic coverings must rely on exterior surface alteration, such as the impregnating of metal granules, before shielding requirements are satisfied; the conductive plastic of the enhanced shield layer 13 is a typical plastic material to which conductive carbon black, conductive metal fiber, or conductive particulate and so on has been added to produce a specialized material capable of conductivity. An enhanced shield capable of reducing electrostatic noise is thereby attainable because conductive plastic and conductive colorant serve as a means that allows the exterior surface of the insulation layer to be finished into a conductive material and, furthermore, enables the hard frictional texture originally present between the shield and the insulation to become a conductive material within having a soft frictional texture to remedy electrostatic discharge-related noise problems. Compared to existent shielding methods, the enhanced shield layer 13 overcomes the drawbacks of foil shielding such as bending fatigue, short service life, and site migration unsuitability, while also solving the major shortcoming of braided and wound shielding, namely their incapability to provide 100 percent isolation.

The said conductor refers to any material capable of electrical conductivity; conductors are typically available in range of certain metals, but can be constructed of any suitable metallic material such as solid copper or multi-stranded copper wire, metal-based coatings containing silver, aluminum, iron, and other metals as well as alloys and other different formulations; the conductor can also be a non-metallic compound having conductive properties.

The said insulation layer, also known as a dielectric, refers to a material suitable for cable insulation such as polyethylene, polypropylene, fluoropolymer, cross-linked polyethylene, rubber, and other similar materials; many insulation materials also contain more than one type of additive such as a flame retardant agent and a mildew-proofing agent.

Referring to FIG. 2, the cross-sectional drawing of another embodiment of the invention herein, 21 is the conductor 22 is the insulation layer of the conductor 21, 23 is the enhanced shield layer, 24 is an axially wrapped aluminum foil, and 25 and 26 are the outer jackets.

Referring to FIG. 3, the cross-sectional drawing of yet another embodiment of the invention herein, 31 is the conductor, 32 is the insulation layer of the conductor 31, 33 is the enhanced shield layer, 34 is the axially wrapped aluminum foil, and 35 and 36 are the outer jackets.

While the said detailed description elaborates workable embodiments of the improved structure of audio cable herein, the said embodiments shall not be construed as a limitation on the patented scope and claims of the present invention and, furthermore, all equivalent adaptations and modifications based on the technological spirit of the present invention shall remain protected within the patented scope and claims of the invention herein.

In summation of the foregoing section, since the invention herein is not only of an original spatial arrangement, but also capable of greater application utility and practical value and, furthermore, no identical or similar product has been disclosed on the market, the present invention is submitted to the examination committee for review and the granting of the commensurate patent rights.

1. An improved structure of a cable comprised of a conductor, an insulation layer, a metal braid layer, and an outer jacket, the feature of which is that an enhanced shield layer is disposed between We said insulation layer and said metal braid layer, said enhanced shield layer being purely formed of conductive carbon black.

2-6. (Canceled).
